(19) United States
(12) Patent Application Publication
(10) Pub. No.: US 2025/0040614 A1
(43) Pub. Date: Feb. 6, 2025

(54) CONTROL METHOD OF ELECTRONIC CIGARETTE WITH CHILD LOCK FUNCTION

(71) Applicant: HUIZHOU HAPPY VAPING TECHNOLOGY LIMITED, Huizhou, Guangdong (CN)

(72) Inventors: Guangrong Lin, Huizhou, Guangdong (CN); Xianbin Zheng, Huizhou, Guangdong (CN)

(21) Appl. No.: 18/716,510

(22) PCT Filed: Jul. 18, 2023
(86) PCT No.: PCT/CN2023/107966

§ 371 Date: Jun. 5, 2024

(30) Foreign Application Priority Data
Sep. 5, 2022 (CN) 202211079625.2

(51) Int. Cl. A24F 40/49; A24F 40/53

(52) U.S. Cl. CPC A24F 40/49; A24F 40/53

(57) ABSTRACT

The disclosure provides a control method of an electronic cigarette with child lock function, wherein a microcontroller of the electronic cigarette is set with child lock control program which comprises steps of: S1. in a locked state of the electronic cigarette, monitoring a signal which indicates that a touch button is touched in real time by the microcontroller; S2. determining whether a duration of time during which the touch button is touched exceeds a first set time by the microcontroller; S3. controlling an LED indicator to light up for a second set time and meanwhile continuously monitoring whether the touch button is consecutively touched by the microcontroller; S4. determining whether a number of times the touch button is consecutively touched in the second set time reaches a set number by the microcontroller; S5. unlocking the electronic cigarette by the microcontroller, to allow the electronic cigarette to enter a stand-by state.

### TECHNICAL FIELD

The disclosure relates to the technical field of the electronic cigarette child lock, more particularly to a control method of an electronic cigarette with a child lock function.

### BACKGROUND

The electronic cigarette usually heats and vaporizes liquid substances or paste-like substances, such as drugs and electronic cigarette liquid, to produce aerosol or vapor for users to vape. As people pay more attention to their health, they realize that tobacco may be harmful to health. Thus, the electronic cigarettes are widely used. As the electronic cigarettes are widely used, however, sometimes the juveniles may have access to the electronic cigarettes at home and may vape like adults without restriction, which may be harmful to the health of the juveniles.

Some of the existing electronic cigarettes have a physical structure which uses for example special-use switches or buttons to limit use for the juveniles. However, they don't have control programs to automatically limit use for the juveniles upon power up or during operation by an automatically determination and control method. In such a circumstance, it is desired to provide a method of unlocking and locking the electronic cigarette upon power up, to prevent the juveniles from using the electronic cigarette.

### SUMMARY

### Technical Problems

The invention aims to provide a control method of an electronic cigarette with a child lock function to overcome the above-mentioned problems.

### Technical Solutions

A technical solution of the invention is as follows. The microcontroller provided in the electronic cigarette is set with a child lock control program which comprises unlocking steps as follows:
S1. When the electronic cigarette device is locked and stop functioning, the microcontroller keeps monitoring a signal indicating the touch button is touched in real time;
S2. once it detects that the touch button is touched, the microcontroller is determining whether the duration of time during which the touch button is touched exceeds a first set time, if yes, go to the next step;
S3. by means of the microcontroller, controlling the LED indicator to light up, wherein the LED indicator is lighted for a second set time, and meanwhile, continuously monitoring whether the touch button is consecutively touched;
S4. once it is detected that the touch button is consecutively touched, determining whether the number of times the touch button is consecutively touched in the second set time reaches a set number by means of the microcontroller, if yes, go to the next step;
S5. by means of the microcontroller, unlocking the electronic cigarette, and lighting up the LED indicator for indication or motor vibration for indication, to allow the electronic cigarette which is unlocked to enter a stand-by state.

Preferably, the step S2 may further comprise: if no, go back to the step S1; the step S4 may further comprise: if no, go back to the step S1.

Preferably, the child lock control program may further comprise locking steps as follows:
S6. once the electronic cigarette enters the stand-by state, monitoring whether the airflow sensor is triggered in real time in a third set time by means of the microcontroller, if no, go to the next step;
S7. microcontroller to lock the electronic cigarette, such that the electronic cigarette enters the locked state and stop functioning, that is, going back to the step S1.

Preferably, the step S2 may further comprise: if no, go back to the step S1; the step S4 may further comprise: if no, go back to the step S1. The step S6 may further comprise: if yes, go to a step S8. It may further comprise the step S8 of controlling the electronic cigarette to enter a working state and monitoring the airflow sensor by means of the microcontroller, and once it is detected that the triggering of the airflow sensor stops, controlling the electronic cigarette to enter the stand-by state and go back to the step S6.

Preferably, the child lock control program may further comprise locking steps as follows:
S6. once the electronic cigarette enters the stand-by state, monitoring the signal indicating the touch button is touched in real time by means of the microcontroller;
S7. once it is detected that the touch button is touched, determining whether the duration of time during which the touch button is touched exceeds the first set time by means of the microcontroller, if yes, go to the next step;
S8. by means of the microcontroller, controlling the LED indicator to light up for the second set time and meanwhile continuously monitoring whether the touch button is consecutively touched;
S9. once it is detected that the touch button is consecutively touched, determining whether the number of times the touch button is consecutively touched in the second set time reaches the set number by means of the microcontroller, if yes, go to the next step;
S10. by means of the microcontroller, locking the electronic cigarette and lighting up the LED indicator for indication or motor vibration for indication, such that the electronic cigarette which is locked enters the locked state, that is, go back to the step S1.

Preferably, the step S2 may further comprise: if no, go back to the step S1; the step S4 may further comprise: if no, go back to the step S1; the step S7 may further comprise: if no, go back to the step S6; and the step S9 may further comprise: if no, go back to the step S6.

Preferably, the first set time may be set to 3-6 seconds.

Preferably, the second set time may be set to 2-5 seconds.

Preferably, the number of times may be set to 3-5.

Preferably, the third set time may be set to 2-30 minutes.

### Advantages

The control method of the electronic cigarette with a child lock function by monitoring touch duration and number of touches to set complicated steps to unlock the device, in such a case, it is difficult for children to find out the visibly hidden touch button, and it is further difficult for children to get access to such complicated unlocking steps without being taught by an adult. Furthermore, it sets certain steps for automatically locking the electronic cigarette within a certain period of time after usage of the electronic cigarette, or sets some steps for manually triggering the touch button to achieve locking in the stand-by state. Hence, it can effectively prevent children from using the electronic cigarette to vape by themselves, and avoid the damage caused thereby.

### BRIEF DESCRIPTION OF THE DRAWINGS

FIG. 1 is a flow chart illustrating a control method according to a first embodiment of the invention;

FIG. 2 is a flow chart illustrating a control method according to a second embodiment of the invention;

FIG. 3 is a flow chart illustrating a control method according to a third embodiment of the invention.

### DETAILED DESCRIPTION OF ILLUSTRATED EMBODIMENTS

To make the purposes, technical solutions and advantages of the invention clear, the invention is described in detail below with reference to the accompanying drawings and embodiments. It should be understood that, the described embodiments are illustrative and are not intended to limit the present invention.

According to the disclosure, an electronic cigarette with a child lock function comprises an electronic cigarette vaporizer and a battery part which are connected with each other. The electronic cigarette vaporizer may be arranged with a heating element which can be energized to work. The heating element may be configured to heat and vaporize the electronic cigarette liquid stored in the electronic cigarette vaporizer, and the electronic cigarette liquid may be heated and vaporized into the vapor or aerosol, i.e., the electronic cigarette smoke. The battery part may be arranged with a circuit control board PCB, and a concealed touch button which is integrated into the surface of the housing of the electronic cigarette and visibly hidden from children. To some extent, such structure limits use for the juveniles. The circuit control board PCB may be provided with a microcontroller for controlling the operation of the electronic cigarette vaporizer. The battery part may be further provided with an airflow sensor for detecting the air flow produced when a user vapes. Once the air flow is detected, the electronic cigarette vaporizer is triggered and activated to energize the heating element to work, and then the electronic cigarette vapor can be produced by the electronic cigarette vaporizer. The electronic cigarette may be further arranged with an LED indicator for indicating a certain working state, or arranged with a vibrating motor for indicating a certain working state by vibration. The electronic cigarette according to the disclosure has a child lock function. It automatically performs unlocking or locking prior to activation or after usage of the electronic cigarette, so as to prevents children from using the electronic cigarette to vape by themselves. The electronic cigarette of the disclosure may be specifically provided with a child lock controlling unit in the control circuit or the microcontroller. It runs the child lock controlling program by means of the child lock controlling unit, so as to control unlocking and locking of the electronic cigarette.

According to a control method of an electronic cigarette with a child lock function of the disclosure, the microcontroller of the electronic cigarette is set with a child lock control program, and the child lock control program comprises unlocking steps as follows.

S1. In the locked state in which the electronic cigarette is inactive, the microcontroller monitors a signal indicating the touch button is touched in real time;

S2. Once it is detected that the touch button is touched, the microcontroller determines whether the duration of time during which the touch button is touched exceeds a first set time, if yes, go to the next step; if no, go back to the step S1;

S3. The microcontroller controls the LED indicator to light up, and the duration of time during which the LED indicator is lighted is a second set time, and meanwhile, continuously monitors whether the touch button is consecutively touched;

S4. Once it is detected that the touch button is consecutively touched, the microcontroller determines whether the number of times the touch button is consecutively touched in the second set time reaches the set number, if yes, go to the next step; if no, go back to the step S1;

S5. The microcontroller unlocks the electronic cigarette, and lights up the LED indicator for indication or vibrates the vibrating motor for indication, and the electronic cigarette which is unlocked enters a stand-by state.

According to a further control method of an electronic cigarette with a child lock function of the disclosure, the microcontroller of the electronic cigarette is set with a child lock control program, and the child lock control program comprises unlocking and locking steps as follows.

S1. In the locked state in which the electronic cigarette is inactive, the microcontroller monitors a signal indicating the touch button is touched in real time;

S2. Once it is detected that the touch button is touched, the microcontroller determines whether the duration of time during which the touch button is touched exceeds a first set time, if yes, go to the next step; if no, go back to the step S1;

S3. The microcontroller controls the LED indicator to light up, and the duration of time during which the LED indicator is lighted is a second set time, and meanwhile, continuously monitors whether the touch button is consecutively touched;

S4. Once it is detected that the touch button is consecutively touched, the microcontroller determines whether the number of times the touch button is consecutively touched in the second set time reaches the set number, if yes, go to the next step; if no, go back to the step S1;

S5. The microcontroller unlocks the electronic cigarette, and lights up the LED indicator for indication or vibrates the vibrating motor for indication, and the electronic cigarette which is unlocked enters a stand-by state;

S6. Once the electronic cigarette enters the stand-by state, the microcontroller monitors whether the airflow sensor is triggered in real time in a third set time, if no, go to the next step; if yes, go to a step S8;

S7. The microcontroller locks the electronic cigarette, and the electronic cigarette which is locked enters the locked state, in which the electronic cigarette is inactive, that is, go back to the step S1;

S8. The microcontroller controls the electronic cigarette to enter a working state and monitors the airflow sensor, and if it is detected that the triggering of the airflow sensor stops, the microcontroller controls the electronic cigarette to enter the stand-by state, and go back to the step S6.

According to a further control method of an electronic cigarette with a child lock function of the disclosure, the microcontroller of the electronic cigarette is set with a child lock control program, and the child lock control program comprises unlocking and locking steps as follows.

S1. In the locked state in which the electronic cigarette is inactive, the microcontroller monitors a signal indicating the touch button is touched in real time;

S2. Once it is detected that the touch button is touched, the microcontroller determines whether the duration of time during which the touch button is touched exceeds a first set time, if yes, go to the next step; if no, go back to the step S1;

S3. The microcontroller controls the LED indicator to light up, and the duration of time during which the LED indicator is lighted is a second set time, and meanwhile, continuously monitors whether the touch button is consecutively touched;

S4. Once it is detected that the touch button is consecutively touched, the microcontroller determines whether the number of times the touch button is consecutively touched in the second set time reaches the set number, if yes, go to the next step; if no, go back to the step S1;

S5. The microcontroller unlocks the electronic cigarette, and lights up the LED indicator for indication or vibrates the vibrating motor for indication, and the electronic cigarette which is unlocked enters a stand-by state;

S6. Once the electronic cigarette enters the stand-by state, the microcontroller monitors the signal indicating the touch button is touched in real time;

S7. Once it is detected that the touch button is touched, the microcontroller determines whether the duration of time during which the touch button is touched exceeds the first set time, if yes, go to the next step; if no, go back to the step S6;

S8. The microcontroller controls the LED indicator to light up, and the duration of time during which the LED indicator is lighted is a second set time, and meanwhile, continuously monitors whether the touch button is consecutively touched;

S9. Once it is detected that the touch button is consecutively touched, the microcontroller determines whether the number of times the touch button is consecutively touched in the second set time reaches the set number, if yes, go to the next step; if no, go back to the step S6;

S10. The microcontroller locks the electronic cigarette, and lights up the LED indicator for indication or vibrates the vibrating motor for indication, and the electronic cigarette which is locked enters the locked state, that is, go back to the step S1.

In the above methods, the first set time may be set to 3-6 seconds, the second set time may be set to 2-5 seconds, the number of times may be set to 3-5, and the third set time may be set to 2-30 minutes.

### EMBODIMENTS OF THE DISCLOSURE

The invention is described in detail with reference to particular embodiments.

### Embodiment 1

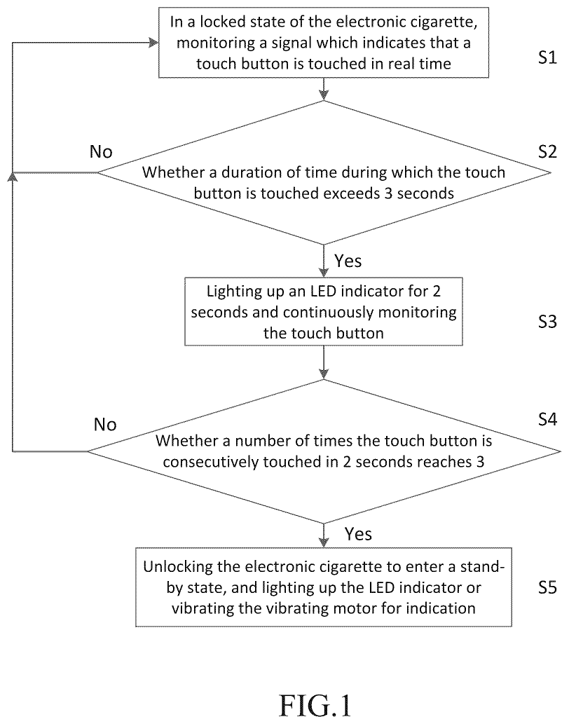

Referring to FIG. 1, in a particular control method of an electronic cigarette with a child lock function according to Embodiment 1 of the disclosure, the microcontroller provided in the electronic cigarette is set with a child lock control program, and the child lock control program comprises unlocking steps as follows.

S1. in the locked state in which the electronic cigarette is inactive, monitoring a signal indicating the touch button is touched in real time by means of the microcontroller;

S2. once it is detected that the touch button is touched, determining whether the duration of time during which the touch button is touched exceeds 3 seconds by means of the microcontroller, if yes, go to the next step; if no, go back to the step S1;

S3. by means of the microcontroller, controlling the LED indicator to light up, wherein the LED indicator is lighted for 2 seconds, and meanwhile, continuously monitoring whether the touch button is consecutively touched;

S4. once it is detected that the touch button is consecutively touched, determining whether the number of times the touch button is consecutively touched in 2 seconds reaches 3 by means of the microcontroller, if yes, go to the next step; if no, go back to the step S1;

S5. by means of the microcontroller, unlocking the electronic cigarette, and lighting up the LED indicator for indication or vibrating the vibrating motor for indication, to allow the electronic cigarette which is unlocked to enter a stand-by state.

The stand-by state as used herein refers to a state in which the electronic cigarette is ready to work. In another word, once the user vapes in such state, the airflow sensor of the electronic cigarette will be triggered, so as to activate the electronic cigarette to work.

### Embodiment 2

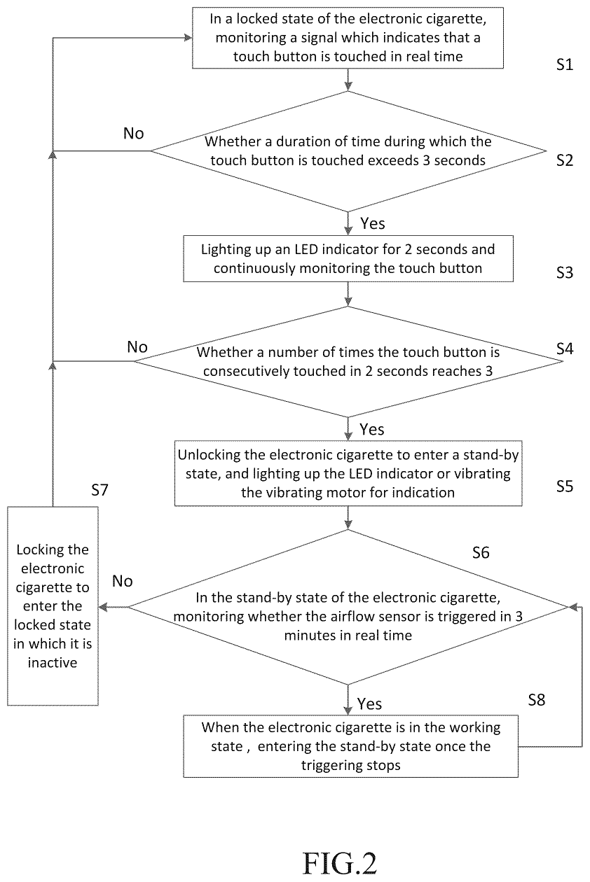

Referring to FIG. 2, in a particular control method of an electronic cigarette with a child lock function according to Embodiment 2 of the disclosure, the microcontroller provided in the electronic cigarette is set with a child lock control program, and the child lock control program comprises unlocking and locking steps as follows.

S1. in the locked state in which the electronic cigarette is inactive, monitoring a signal indicating the touch button is touched in real time by means of the microcontroller;

S2. once it is detected that the touch button is touched, determining whether the duration of time during which the touch button is touched exceeds 3 seconds by means of the microcontroller, if yes, go to the next step; if no, go back to the step S1;

S3. by means of the microcontroller, controlling the LED indicator to light up, wherein the LED indicator is lighted for 2 seconds, and meanwhile continuously monitoring whether the touch button is consecutively touched;

S4. once it is detected that the touch button is consecutively touched, determining whether the number of times the touch button is consecutively touched in 2 seconds reaches 3 by means of the microcontroller, if yes, go to the next step; if no, go back to the step S1;

S5. by means of the microcontroller, unlocking the electronic cigarette, and lighting up the LED indicator for indication or vibrating the vibrating motor for indication, to allow the electronic cigarette which is unlocked to enter a stand-by state;

S6. once the electronic cigarette enters the stand-by state, by means of the microcontroller, monitoring whether the airflow sensor is triggered in real time in 5 minutes, if no, go to the next step; if yes, go to a step S8;

S7. by means of the microcontroller, locking the electronic cigarette such that the electronic cigarette which is locked enters the locked state and stop functioning, that is, going back to the step S1;

S8. by means of the microcontroller, controlling the electronic cigarette to enter a working state and monitoring the airflow sensor; once it is detected that the triggering of the airflow sensor stops, controlling the electronic cigarette to enter the stand-by state and going back to the step S6.

In the embodiment, the locking steps achieve an automatic locking process which runs depending on time.

### Embodiment 3

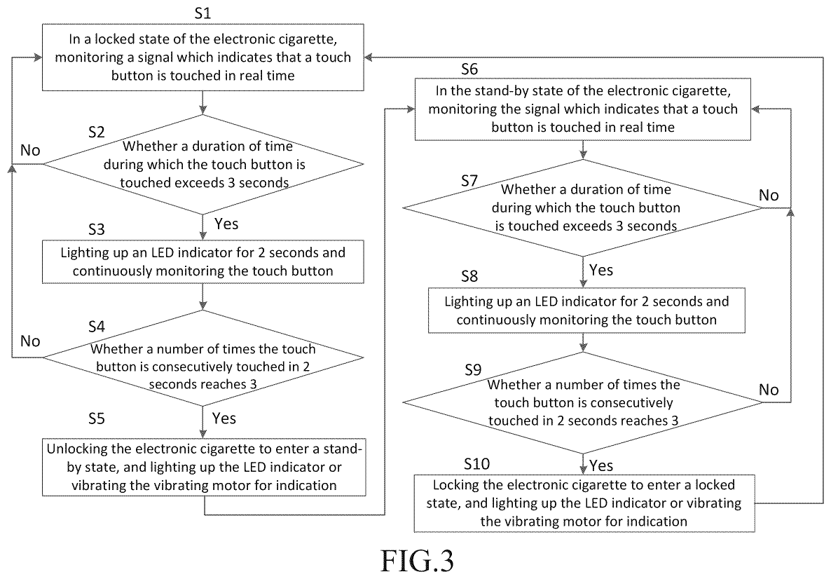

Referring to FIG. 3, in a particular control method of an electronic cigarette with a child lock function according to Embodiment 3 of the disclosure, the microcontroller provided in the electronic cigarette is set with a child lock control program, and the child lock control program comprises unlocking and locking steps as follows.

S1. in the locked state in which the electronic cigarette is inactive, monitoring a signal indicating the touch button is touched in real time by means of the microcontroller;

S2. once it is detected that the touch button is touched, determining whether the duration of time during which the touch button is touched exceeds 3 seconds by means of the microcontroller, if yes, go to the next step; if no, go back to the step S1;

S3. by means of the microcontroller, controlling the LED indicator to light up, wherein the LED indicator is lighted for 2 seconds, and meanwhile continuously monitoring whether the touch button is consecutively touched;

S4. once it is detected that the touch button is consecutively touched, determining whether the number of times the touch button is consecutively touched in 2 seconds reaches 3 by means of the microcontroller, if yes, go to the next step; if no, go back to the step S1;

S5. by means of the microcontroller, unlocking the electronic cigarette, and lighting up the LED indicator for indication or vibrating the vibrating motor for indication, to allow the electronic cigarette which is unlocked to enter a stand-by state;

S6. once the electronic cigarette enters the stand-by state, monitoring the signal indicating the touch button is touched in real time by means of the microcontroller;

S7. once it is detected that the touch button is touched, determining whether the duration of time during which the touch button is touched exceeds 3 seconds by means of the microcontroller, if yes, go to the next step; if no, go back to the step S6;

S8. by means of the microcontroller, controlling the LED indicator to light up, wherein the LED indicator is lighted for 2 seconds, and meanwhile, continuously monitoring whether the touch button is consecutively touched;

S9. once it is detected that the touch button is consecutively touched, determining whether the number of times the touch button is consecutively touched in 2 seconds reaches 3 by means of the microcontroller, if yes, go to the next step; if no, go back to the step S6;

S10. by means of the microcontroller, locking the electronic cigarette and lighting up the LED indicator for indication or vibrating the vibrating motor for indication, to allow the electronic cigarette which is locked to enter the locked state, that is, go back to the step S1.

In the embodiment, the locking steps achieve a manual locking process which runs as needed.

In further embodiments, the respective set time and the number of times may be set in other appropriate ways.

The particular control methods of an electronic cigarette with a child lock function according to the disclosure comprises a control program for unlocking and locking. By monitoring touch duration and number of touches for the visibly hidden touch button, it sets complicated steps required for unlocking of the electronic cigarette. In such a case, it is difficult for children to find out the visibly hidden touch button, and it is further difficult for children to get access to such complicated unlocking steps without being taught by an adult. Furthermore, it sets some steps for automatically locking the electronic cigarette within a certain period of time after usage of the electronic cigarette, or sets some steps for manually triggering the touch button to achieve locking in the stand-by state. Hence, it effectively prevents children from using the electronic cigarette to vape by themselves, and avoid the damage caused thereby.

### INDUSTRIAL APPLICABILITY

All the above are merely preferred embodiments of the disclosure. The present invention is intended to cover all modifications and equivalent arrangements claimed by the present invention.

The invention claimed is:

1. A control method of an electronic cigarette with a child lock function, wherein a microcontroller provided in the electronic cigarette is set with a child lock control program which comprises unlocking steps of:
S1. in a locked state in which the electronic cigarette is inactive, monitoring a signal which indicates that a touch button is touched in real time by means of the microcontroller;
S2. once it is detected that the touch button is touched, determining whether a duration of time during which the touch button is touched exceeds a first set time by means of the microcontroller, if yes, go to the next step;
S3. by means of the microcontroller, controlling an LED indicator to light up for a second set time and meanwhile continuously monitoring whether the touch button is consecutively touched;
S4. once it is detected that the touch button is consecutively touched, determining whether a number of times the touch button is consecutively touched in the second set time reaches a set number by means of the microcontroller, if yes, go to the next step;
S5. by means of the microcontroller, unlocking the electronic cigarette, and lighting up the LED indicator for indication or vibrating the vibrating motor for indication, to allow the electronic cigarette which is unlocked to enter a stand-by state.

2. The control method of an electronic cigarette with a child lock function according to claim 1, wherein the step S2 further comprises: if no, go back to the step S1; the step S4 further comprises: if no, go back to the step S1.

3. The control method of an electronic cigarette with a child lock function according to claim 1, wherein the child lock control program further comprises locking steps of:
S6. once the electronic cigarette enters the stand-by state, monitoring whether an airflow sensor is triggered in real time in a third set time by means of the microcontroller, if no, go to the next step;
S7. locking the electronic cigarette by means of the microcontroller, to allow the electronic cigarette which is locked to enter the locked state, in which the electronic cigarette is inactive, that is, go back to the step S1.

4. The control method of an electronic cigarette with a child lock function according to claim 3, wherein the step S2 further comprises: if no, go back to the step S1; the step S4 further comprises: if no, go back to the step S1; the step S6 further comprises: if yes, go to a step S8, wherein the control method further comprises the step S8 of controlling the electronic cigarette to enter a working state and monitoring the airflow sensor by means of the microcontroller, and once it is detected that a triggering of the airflow sensor stops, controlling the electronic cigarette to enter the stand-by state and go back to the step S6.

5. The control method of an electronic cigarette with a child lock function according to claim 1, wherein the child lock control program further comprises locking steps of:
S6. once the electronic cigarette enters the stand-by state, monitoring the signal indicating the touch button is touched in real time by means of the microcontroller;
S7. once it is detected that the touch button is touched, determining whether a duration of time during which the touch button is touched exceeds the first set time by means of the microcontroller, if yes, go to the next step;
S8. by means of the microcontroller, controlling the LED indicator to light up for the second set time and meanwhile continuously monitoring whether the touch button is consecutively touched;
S9. once it is detected that the touch button is consecutively touched, determining whether a number of times the touch button is consecutively touched in the second set time reaches the set number by means of the microcontroller, if yes, go to the next step;
S10. by means of the microcontroller, locking the electronic cigarette and lighting up the LED indicator for indication or vibrating the vibrating motor for indication, to allow the electronic cigarette which is locked to enter the locked state, that is, go back to the step S1.

6. The control method of an electronic cigarette with a child lock function according to claim 5, wherein the step S2 further comprises: if no, go back to the step S1; the step S4 further comprises: if no, go back to the step S1; the step S7 further comprises: if no, go back to the step S6; and the step S9 further comprises: if no, go back to the step S6.

7. The control method of an electronic cigarette with a child lock function according to claim 1, wherein the first set time is set to 3-6 seconds.

8. The control method of an electronic cigarette with a child lock function according to claim 1, wherein the second set time is set to 2-5 seconds.

9. The control method of an electronic cigarette with a child lock function according to claim 1, wherein the number of times is set to 3-5.

10. The control method of an electronic cigarette with a child lock function according to claim 3, wherein the third set time is set to 2-30 minutes.
